(19) United States
(12) Patent Application Publication
(10) Pub. No.: US 2026/0310684 A1
(43) Pub. Date: Oct. 8, 2026

(54) MULTIPLE VISUAL REPRESENTATIONS BASED ON SOURCE DATA

(71) Applicant: Lucid Software, Inc., South Jordan, UT (US)

(72) Inventors: Tyler Davis, South Jordan, UT (US); Anthony Morelli, South Jordan, UT (US); Benjamin Dilts, South Jordan, UT (US)

(21) Appl. No.: 19/631,941

(22) Filed: Mar. 27, 2026

Related U.S. Application Data
(60) Provisional application No. 63/782,556, filed on Apr. 2, 2025.

(51) Int. Cl. G06F 16/26; G06F 3/0482; G06F 40/103; G06T 11/26

(52) U.S. Cl. CPC G06F 16/26; G06F 40/103; G06T 11/26; G06F 3/0482

(57) ABSTRACT

An example method may include obtaining source data that is arranged in accordance with a field. The method also includes generating a chart indicating an association of the field and a pre-determined field. In addition, the method includes displaying a menu within a canvas. The menu identifies a plurality of formats for generating visual representations to be representative of the source data within the canvas. Further, the method includes generating a plurality of visual representations of the source data within the canvas based on the chart and user input that is effective to select two formats of the plurality of formats.

### CROSS-REFERENCE TO RELATED APPLICATION

This patent application claims the benefit of and priority to U.S. Provisional App. No. 63/782,556 filed Apr. 2, 2025 titled “MULTIPLE VISUAL REPRESENTATIONS BASED ON SOURCE DATA,” which is incorporated in the present disclosure by reference in its entirety.

### FIELD

The embodiments discussed herein are related to multiple visual representations based on source data.

### BACKGROUND

Unless otherwise indicated herein, the materials described herein are not prior art to the claims in the present application and are not admitted to be prior art by inclusion in this section.

Some systems may receive source data that is arranged in accordance with a data format. These systems may generate visual representations in a digital canvas in accordance with different visual formats based on the source data. At least some portions of the data formats may not be compatible with or may not directly apply to at least some portions of the visual formats.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, a method may include obtaining source data that is arranged in accordance with a field. The method may also include generating a chart indicating an association of the field and a pre-determined field. In addition, the method may include displaying a menu within a canvas. The menu may identify a plurality of formats for generating visual representations to be representative of the source data within the canvas. Further, the method may include generating a plurality of visual representations of the source data within the canvas based on the chart and user input that is effective to select two or more formats of the plurality of formats.

In another example embodiment, a non-transitory computer-readable medium having computer-readable instructions stored thereon that are executable by a processor to perform or control performance of operations is disclosed. The operations may include obtaining source data that is arranged in accordance with a field. The operations may also include generating a chart indicating an association of the field and a pre-determined field. In addition, the operations may include displaying a menu within a canvas. The menu may identify a plurality of formats for generating visual representations to be representative of the source data within the canvas. Further, the operations may include generating a plurality of visual representations of the source data within the canvas based on the chart and user input that is effective to select two or more formats of the plurality of formats.

In another example embodiment, a system comprising: one or more computer-readable storage media configured to store instructions; and one or more processors communicatively coupled to the one or more computer-readable storage media and configured to, in response to execution of the instructions, cause the system to perform operations. The operations may include obtaining source data that is arranged in accordance with a field. The operations may also include generating a chart indicating an association of the field and a pre-determined field. In addition, the operations may include displaying a menu within a canvas. The menu may identify a plurality of formats for generating visual representations to be representative of the source data within the canvas. Further, the operations may include generating a plurality of visual representations of the source data within the canvas based on the chart and user input that is effective to select two or more formats of the plurality of formats.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a block diagram of an example operating environment for a computing device configured to generate multiple visual representations based on source data;

FIGS. 2A and 2B illustrate a process diagram to generate examples of the visual representations of FIG. 1 based on the source data of FIG. 1;

FIG. 3 illustrates a graphical representation of a user interface (UI) including the canvas of FIG. 1;

FIG. 4 illustrates a graphical representation of a UI including the canvas of FIG. 1 and two visual representations that have been modified or updated;

FIG. 5 illustrates an example of the source data of FIG. 1 and a menu including a selection field to associate fields within source data with pre-determined fields of a chart;

FIG. 6 illustrates a flowchart of an example method to generate multiple visual representations based on source data; and

FIG. 7 is a block diagram illustrating an example computing device that is arranged to facilitate generation of multiple visual representations based on source data,

all arranged in accordance with at least one embodiment described herein.

### DETAILED DESCRIPTION OF SOME EXAMPLE EMBODIMENTS

The source data may include information that is arranged and stored in fields in accordance with the data format. For example, the information of the source data may be arranged and stored in fields in accordance with a separated values (SV) format (e.g., comma SV, tab SV, or space SV), JavaScript object notation (JSON) format, a JSON lines format, a parquet format, an optimized row columnar (ORC) format, an Avro format, an excel (XLS) format, a Word (DOC) format, a portable document format (PDF), a cloud data format, a project management data format, a user data format, or any other appropriate data format. The fields of the source data may be identified (e.g., named) in accordance with the data format. Additionally or alternatively, the information of the source data may be stored in the fields in a computer language or using symbols in accordance with the data format.

Some visual representation technologies may generate visual representations based on the source data such that the visual representations display information in accordance with visual formats. For example, the information may be displayed in the visual representations in accordance with an enhanced metafile format (EMF), encapsulated PostScript (EPS) format, a scalable vector graphics (SVG) format, a container format, a card format, a dynamic table format, a mind map format, an organizational chart format, a timeline format, a tree format, a portable document format, a joint photographic experts group format, a portable network graphics format, or any other appropriate visual format. When multiple visual representations are generated, these visual representation technologies may map information from the fields of the source data to fields of the corresponding visual formats multiple times (e.g., once per visual representation) because of differences in fields of the different visual formats.

These visual representation technologies may not map one or more portions of the source data to one or more portions of the visual formats because these portions of the source data may not be compatible with or be directly associated with one or more fields of the visual formats. For instance, one or more fields of the source data may include different labels than one or more fields of the visual formats that correspond to similar information. For example, these visual representation technologies may not map a field in the source data labelled “job” to a field labelled “title” in a visual format despite both fields being directed to similar information.

Some visual representation technologies may map the fields of the source data to fields of some visual formats while not mapping the same fields of the source data to fields of other visual formats despite all the fields being directed to similar information. For example, these visual representation technologies may map the field labelled “job” in the source data to the field labelled “title” of a first visual format but not to a field labelled “position” of a second visual format even though all three fields correspond to similar information. In addition, these visual representation technologies may not map some fields of the source data to any of the fields of the visual formats despite the field of the source data corresponding to similar information as one or more fields of the visual formats. For example, these visual representation technologies may not map the field labelled “country” in the source data to any fields of the visual formats despite one or more of the visual formats including a field labelled “location.”

Accordingly, generating multiple visual representations in accordance with different visual formats based on the same source data may cause inconsistencies between information that is displayed in the visual representations. Continuing the field labelled “job” example, some visual representation technologies may generate a first visual representation arranged in accordance with the first visual format without information in the field labelled “title,” but may generate a second visual representation arranged in accordance with the second visual format with information in the field labelled “position” even though both fields of these visual formats correspond to similar information.

Therefore, there is a need for systems and methods that can generate multiple visual representations corresponding to different visual formats based on the same source data (e.g., a single instance of the source data).

The present disclosure provides techniques and systems to generate multiple visual representations of the source data within the digital canvas (referred to in the present disclosure as “canvas”). Some embodiments described in the present disclosure may include a computing device that obtains the source data. The source data may be arranged in accordance with the data format including multiple fields. In addition, the computing device may generate a chart. The chart may indicate an association of one or more of the fields of the source data with one or more pre-determined fields (e.g., intermediate fields). Further, the pre-determined fields may be pre-associated with fields of the different visual formats of the visual representations. The computing device may display a menu within the canvas. The menu may identify the visual formats for generating the visual representations within the canvas. Additionally, the computing device may generate the visual representations within the canvas based on the chart and user input that is effective to select two or more of the visual formats.

The computing devices and methods described in the present disclosure can generate multiple visual representations that include different visual formats based on the single instance of the source data. Additionally, the computing device and methods can generate the visual representations while maintaining consistency across the information displayed in the visual representations. Further, the computing devices and methods allow the source data in the data format to be compatible with multiple different visual formats. Further, the computing device and methods described herein may generate multiple visual representations while only mapping the fields of the data format a single time. Accordingly, the computing devices and methods described in the present disclosure provide improvements over other visual representation technologies when generating multiple visual representations based on a single instance of source data.

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

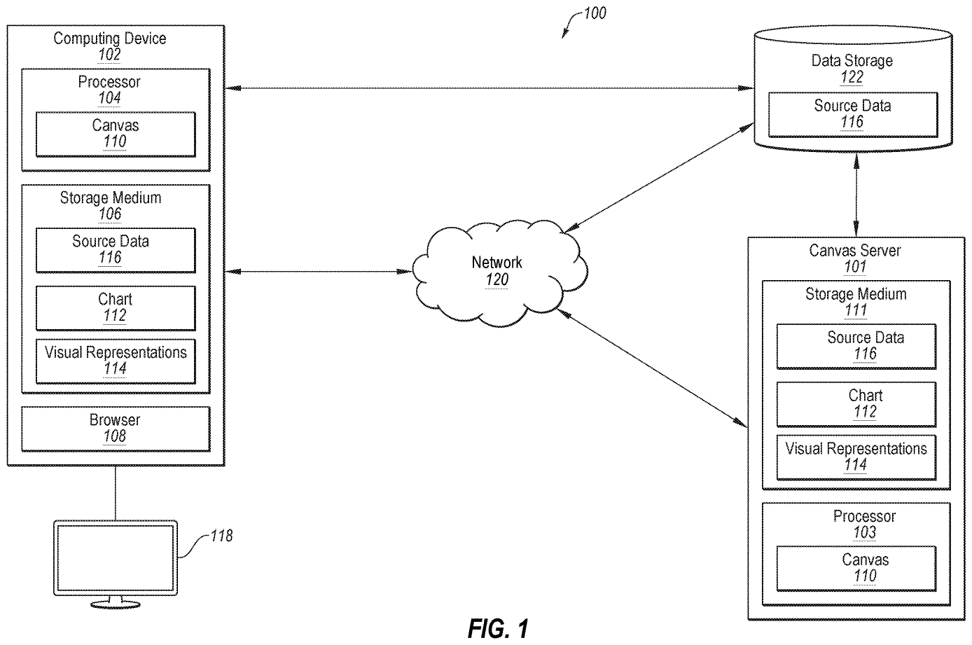

FIG. 1 illustrates a block diagram of an example operating environment 100 for a computing device 102 configured to generate multiple visual representations 114 based on source data 116, arranged in accordance with at least one embodiment described herein. As shown in FIG. 1, the environment 100 includes the computing device 102, a network 120, a data storage 122, and a canvas server 101.

The computing device 102 may include a desktop computer, a laptop computer, a tablet computer, a mobile phone, a smartphone, a personal digital assistant (PDA), a wearable device (e.g., a smart watch), an interactive whiteboard (e.g., SURFACE HUB) or another suitable client device. The computing device 102 may include a processor 104, storage medium 106, or both that hosts a canvas 110 to allow the computing device 102 to generate the visual representations 114 and/or a chart 112. Additionally, the canvas 110 may allow the computing device 102 to reflect changes made to the visual representations 114, the chart 112, or both. For example, the canvas 110 may allow the computing device 102 to reflect changes made to the chart 112 to corresponding visual representations 114 or vice versa.

The canvas server 101 may be a computer system that provides services to the computing device 102 over the network 120. The canvas server 101 may include hardware components such as processor 103 and storage medium 111 that host the canvas 110 to allow the canvas server 101 to generate the visual representations 114 and/or the chart 112. Additionally, the canvas 110 may allow the canvas server 101 to reflect changes made to the visual representations 114, the chart 112, or both. For example, the canvas 110 may allow the canvas server 101 to reflect changes made to the chart 112 to corresponding visual representations 114 or vice versa.

The processors 103 or 104 may be of any type such as a central processing unit (CPU), a microprocessor (μP), a microcontroller (μC), a digital signal processor (DSP), or any combination thereof. The processors 103 or 104 may be configured to execute computer instructions that, when executed, cause the processors 103 or 104 to perform or control performance of one or more of the operations described herein with respect to the computing device 102 or the canvas server 101.

The storage mediums 106 or 111 may include any non-transitory computer-readable medium, including volatile memory such as RAM, persistent or non-volatile storage such as ROM, EEPROM, CD-ROM or other optical disk storage, magnetic disk storage or other magnetic storage device, NAND flash memory or other solid state storage device, or other persistent or non-volatile computer storage medium. The storage mediums 106 or 111 may store computer instructions that may be executed by the processors 103 or 104 to perform or control performance of one or more of the operations described herein with respect to the computing device 102 or the canvas server 101.

The storage mediums 106 or 111 may additionally store the source data 116, the chart 112, or the visual representations 114. The source data 116 may be generated for the chart 112 and/or the visual representations 114 and/or may be imported from the canvas server 101, the data storage 122, or the computing device 102. The source data 116 may be imported over the network 120 or directly from the data storage 122, the canvas server 101, or the computing device 102 if a direct connection exists.

The computing device 102 may execute an application, such as a browser 108, configured to communicate through the network 120 with the canvas server 101, the data storage 122, or both. The browser 108 may include an Internet browser or other suitable application to communicate through the network 120 with the canvas server 101, the data storage 122, or both. The browser 108 may generate, download and/or interact with the canvas 110, the source data 116, the chart 112, and/or the visual representations 114. In some embodiments, the computing device 102 may display the browser 108 including the canvas 110, the visual representations 114, the source data 116, or the chart 112 via a display 118.

Embodiments described herein are not limited to using the browser 108 to communicate with the canvas server 101 or the data storage 122 to generate the visual representations 114. For example, rather than or in addition to the browser 108, the computing device 102 may include a native app as are often used on computing devices such as mobile devices including smartphones, tablet computers, and interactive whiteboards. Accordingly, embodiments described herein generally include generating the visual representations 114 using a browser, a native app, or another suitable application on the computing device 102.

In general, the network 120 may include one or more wide area networks (WANs) and/or local area networks (LANs) that enable the canvas server 101, the computing device 102, and the data storage 122 to communicate with each other. In some embodiments, the network 120 may include the Internet, including a global internetwork formed by logical and physical connections between multiple WANs and/or LANs. Alternately or additionally, the network 120 may include one or more cellular radio frequency (RF) networks and/or one or more wired and/or wireless networks such as 802.xx networks, Bluetooth access points, wireless access points, Internet Protocol (IP)-based networks, or other wired and/or wireless networks. The network 120 may also include servers that enable one type of network to interface with another type of network.

The data storage 122 may include any memory or data storage. The data storage 122 may include network communication capabilities such that other components in the environment 100 may communicate with the data storage 122. In some embodiments, the data storage 122 may include computer-readable storage media for carrying or having computer-executable instructions or data structures stored thereon. The computer-readable storage media may include any available media that may be accessed by a general-purpose or special-purpose computer, such as a processor. For example, the data storage 122 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the data storage 122.

In some embodiments, the canvas server 101 and/or the computing device 102 may allow users to generate the visual representations 114 within the canvas 110 based on the source data 116 via the processor 103 of the canvas server 101, the processor 104 of the computing device 102, or both. The visual representations 114 (e.g., graphical diagrams or visualizations) may include graphical objects representative of information in the source data 116. As an example, the canvas 110 may include a virtual whiteboard application, for example, LUCIDSPARK, MURAL, MIRO, CONCEPTBOARD, ZITEBOARD, MICROSOFT WHITEBOARD, or other virtual whiteboard application.

The canvas 110 as used herein may refer to a document or other file that includes graphical objects generated, formatted, and/or grouped by users on a graphical drawing canvas. Alternatively or additionally, the canvas 110 may include data collections and/or pointers to data collections used to generate, format, or group graphical objects.

Although one computing device 102, one canvas server 101, and one data storage 122 are illustrated in FIG. 1, the environment 100 may more generally include one or more canvas servers 101, one or more computing devices 102, or one or more data storages 122. In these and other embodiments, the environment 100 may include other servers and/or devices not illustrated in FIG. 1.

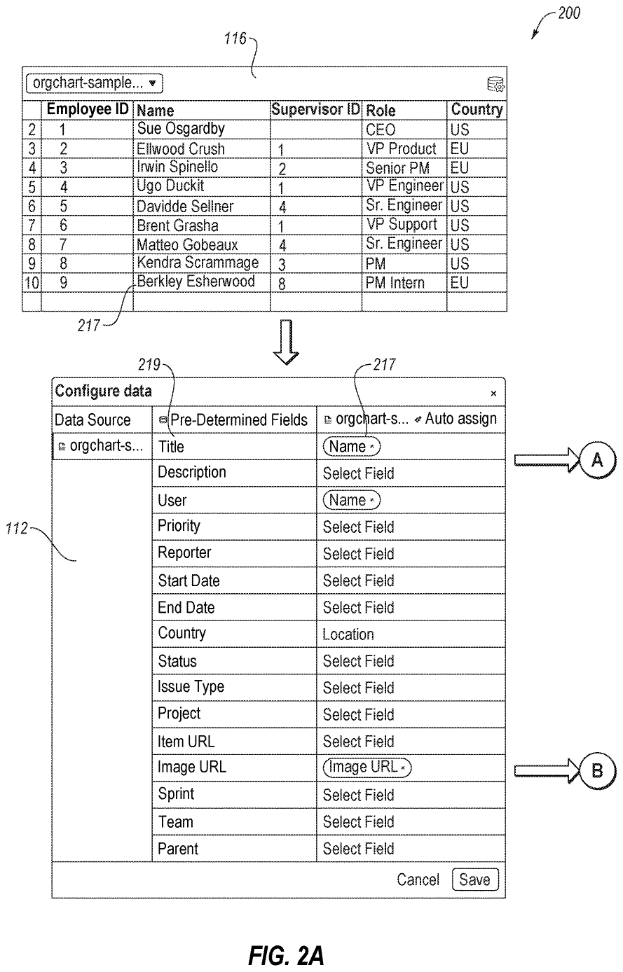

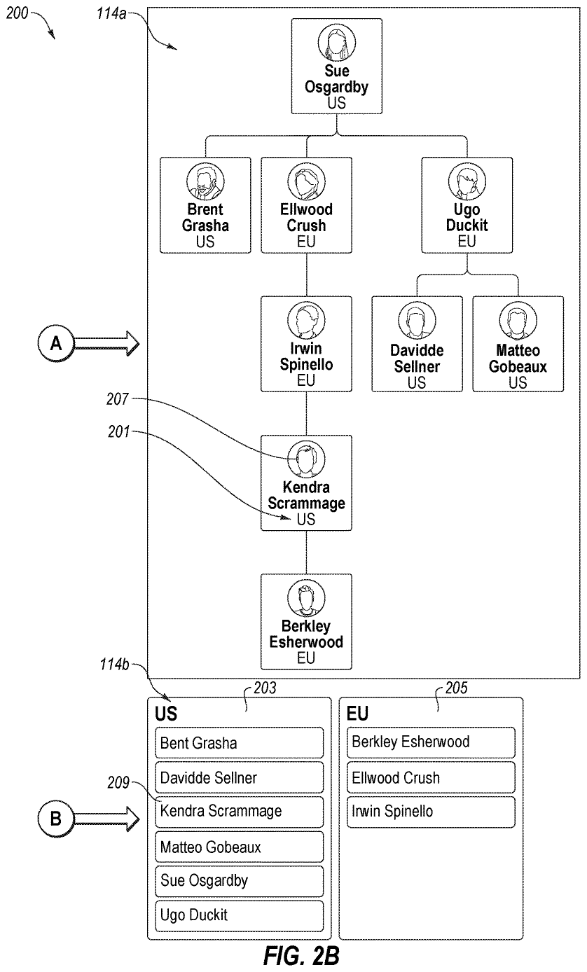

FIGS. 2A and 2B illustrate a process diagram 200 to generate examples of the visual representations 114a-b of FIG. 1 based on the source data 116 of FIG. 1, arranged in accordance with at least one embodiment described herein. Aspects described as being performed by the processor 104 of the computing device 102 may be performed by the processor 103 of the canvas server 101 and vice versa. For ease of discussion, the following discussion describes the processor 104 of the computing device 102 as performing the various aspects. However, these aspects may be performed by the processor 103 of the canvas server 101 in addition to or instead of the processor 104.

With combined reference to FIGS. 1 and 2, the processor 104 may obtain the source data 116. For example, the processor 104 may obtain the source data 116 from the data storage 122, the canvas server 101, or both. Additionally or alternatively, the processor 104 may generate at least part of the source data 116 based on user input.

The source data 116 can include information arranged and stored in fields 217 in accordance with a data format. For example, the information of the source data 116 may be arranged and stored in fields in accordance with a SV format (e.g., comma SV, tab SV, or space SV), JSON format, a JSON lines format, a parquet format, an ORC format, an Avro format, an XLS format, a DOC format, a PDF, a cloud data format, a project management data format, a user data format, or any other appropriate data format. A single instance of the fields is numbered 217 in FIG. 2A for ease of illustration.

An example of the source data 116 according to a CSV format is provided in Table 1.

TABLE 1

| Employee | | Supervisor | | Loca- |
|---|---|---|---|---|
| ID | Name | ID | Role | tion |
| 1 | Sue Osgardby | | CEO | US |
| 2 | Elwood Crush | 1 | VP Production | EU |
| 3 | Irwin Spinello | 2 | Senior PM | EU |
| 4 | Ugo Duckit | 1 | VP Engineering | US |
| 5 | Davidde Sellner | 4 | Sr. Engineer | US |
| 6 | Brent Grasha | 1 | VP Support | US |
| 7 | Matteo Gobeaux | 4 | Sr. Engineer | US |
| 8 | Kendra Scrammage | 3 | PM | US |
| 9 | Berkley Esherwood | 8 | PM Intern | EU |

In Table 1, “US” represents the United States and “EU” represents the European Union.

The fields 217 may include specific data values representative of the information. Additionally, the fields 217 may be identified (e.g., named) in accordance with the data format. For example, the fields 217 may include specific data representative of and labelled as “Employee ID,” “Name,” “Supervisor ID,” and “Role” of people as listed in Table 1 and shown in FIGS. 2A and 2B. In some embodiments, the data format of the source data 116 may include a known schema or an unknown schema.

The processor 104 may generate the chart 112 based on the source data 116, pre-determined fields 219, the schema of the source data 116, or any other appropriate aspect. A single instance of the pre-determined fields is numbered 219 in FIG. 2A for ease of illustration. The processor 104 may generate the chart 112 in accordance with a second format comprising the pre-determined fields 219.

The chart 112 may indicate an association of one or more of the fields 217 with one or more pre-determined fields 219. For example, the chart 112 may indicate an association between the data format (e.g., a first format) and the format of the chart 112 (e.g., a second format). The association of the fields 217 and the pre-determined fields 219 in the chart 112 indicates a relationship (e.g., an association) between the data format and the second format. For example, as shown in FIG. 2A, the pre-determined field 219 is labelled “Title” and the chart 112 indicates that it is associated with the field 217 labelled “Name” in the source data 116. As another example, as shown in FIG. 2A, the chart 112 indicates that the pre-determined field labelled “User” is associated with the field labelled “Name” in the source data 116 and the pre-determined field called “Image URL” is associated with the field “Image URL” in the source data 116.

Table 2 lists examples of the fields 217 of the source data 116 that are associated with and the pre-determined fields 219 of the chart 112.

TABLE 2

| Pre-Determined Field | Field of the Source Data |
|---|---|
| Title | Name |
| User | Name |
| Country | Location |
| Image URL | Image URL |

In some embodiments, the processor 104 may associate the fields 217 of the source data 116 with the pre-determined fields 219. If the source data 116 includes a known schema, the processor 104 may automatically associate the fields 217 of the source data 116 with the pre-determined fields 219 of the chart 112. Alternatively, if the source data 116 includes an unknown schema, the processor 104 may request the user to provide additional user input providing a description of the unknown schema (e.g., description or names of the fields in the unknown schema). For example, the processor 104 may instruct the user to manually associate the fields 217 in the source data 116 of the unknown schema with the pre-determined fields 219 of the chart 112.

The processor 104 may copy information from the source data 116 into the chart 112. For example, the processor 104 may extract information from the source data 116 corresponding to the fields 217 of the source data 116 and add that information to or populate the corresponding pre-determined fields 219 of the chart 112. For example, the processor 104 may extract the information corresponding to the field labelled “Name” in the source data 116 and populate the field labelled “Title” and “User” with the extracted information. Accordingly, the chart 112 may include the information of the source data 116 but arranged in a different order.

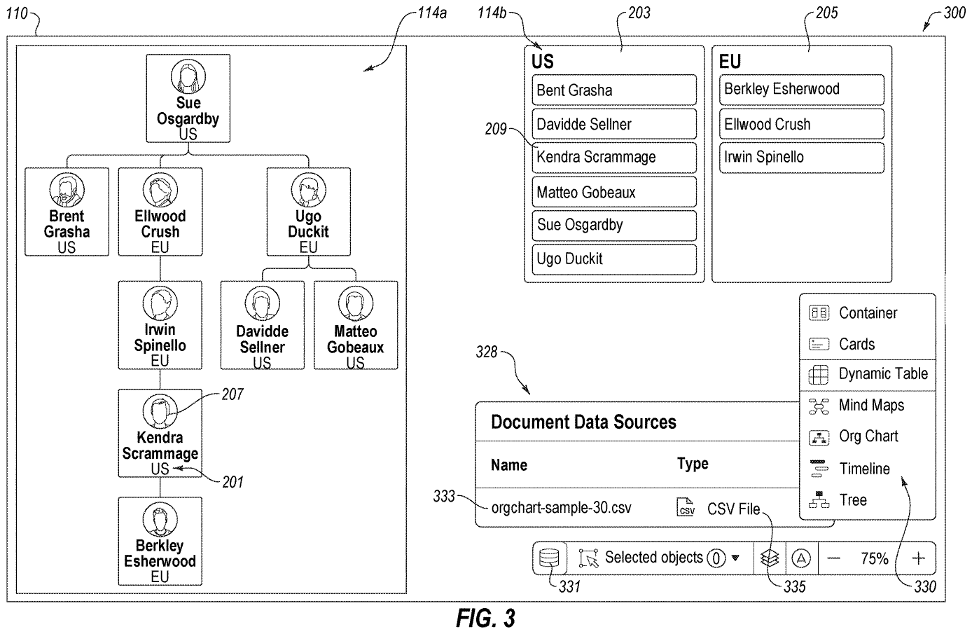

The processor 104 may cause a menu (such as menu 328 in FIG. 3) to be displayed within the canvas 110. The menu may identify various visual formats for generating the visual representations 114a-b. The menu may include a menu arrangement that is fixed or movable within or around the canvas 110 including one or more of the menu options for selecting the visual formats. The menu 328 and the various formats are described in more detail below in relation to FIG. 3.

In some embodiments, the pre-determined fields 219 in the chart 112 may be pre-associated with fields of the visual representations 114 in the visual formats. For example, the pre-determined fields 219 may be pre-mapped to one or more fields of the various visual formats of the visual representations 114. For example, the “Image URL” pre-determined field 219 may be pre-associated with a headshot field 207 of the visual format of the visual representations 114a. A single instance of the headshot fields 207 and the location fields 201 are numbered in FIG. 2B for ease of illustration. As another example, the “Country” pre-determined field 219 may be pre-associated with a location field 201 of the visual representation 114a and labels of location containers 203 and 205. To associate the pre-determined fields 219 of the chart 112 with the fields of the visual representations 114, the processor 104 may implement a standard deviation function on all fields to determine which ones correspond to related or similar information.

The processor 104 may receive user input effective to select multiple visual formats that are shown in the menu. The processor 104 may generate the multiple visual representations 114a-b in the canvas 110 based on the selected visual formats. The processor 104 may generate the visual representations 114a-b to display information within the source data 116 in different formats. For example, as shown in FIG. 2B, the visual representation 114a includes an organizational chart (e.g., org chart) and the visual representation 114b includes a container format. As shown in FIG. 2B, the visual representation 114b includes location containers 203 and 205 with name cards 209. A single instance of the name cards 209 is numbered in FIG. 2B for ease of illustration. Accordingly, the processor 104 may generate the multiple visual representations 114a-b with different formats based on a single instance of the source data 116.

As shown in FIG. 2B, the visual representation 114a includes an organizational chart that includes headshot fields 207 and location fields 201. The location fields 201 indicate the country (e.g., the US or the EU) in which the corresponding person works or resides. Accordingly, the visual representation 114a may display hierarchical relationships between people and locations of the people identified in the source data 116.

Each of the containers 203 and 205 indicates a different location in which the corresponding people work or reside. For example, the location container 203 corresponds to the US and includes the name cards 209 for Brent Grasha, Davidde Sellner, Kendra Scrammage, Matteo Gobeaux, Sue Osgardby, and Ugo Duckit indicating that these people work or reside in the US. As another example, the location container 205 corresponds to the EU and includes the name cards for Berkley Esherwood, Elwood Crush, and Irwin Spinello indicating that these people work or reside in the EU.

FIG. 3 illustrates a graphical representation of a UI 300 including the canvas 110 of FIG. 1, arranged in accordance with at least one embodiment described herein. The UI 300 may be provided by the browser 108 of FIG. 1. For instance, the browser 108 in cooperation with the processor 104 may present the UI 300 of FIG. 3 to the user through and/or on the display 118. The UI 300 includes the canvas 110, the visual representations 114a-b, a menu bar 331, and a menu 328.

In some embodiments, the menu 328 may be displayed in the UI 300 based on user input. For example, the user may click, touch, or otherwise engage with the menu bar 331 to cause the menu 328 to be displayed. In other embodiments, the menu 328 may be displayed in the UI 300 without receiving the user input. The menu 328 may include a filename field 333, a filetype field 335, and a format field 330.

The filename field 333 may display a filename of the source data 116. In addition, the filetype field 335 may display a type of file (e.g., the data format) of the source data 116. Further, the format field 330 may display (e.g., identify) multiple visual format options. As shown in FIG. 3, the multiple visual format options include a “Container” visual representation, a “Cards” visual representation, a “Dynamic Table” visual representation, a “Mind Maps” visual representation, an “Org Chart” visual representation, a “Timeline” visual representation, and a “Tree” visual representation. However, the menu 328 may display any appropriate visual format option.

The user may select two or more of the visual formats in the formats field 330 to cause the processor 104 of FIG. 1 to generate the visual representations 114a-b. For example, the user may select the “Org Chart” visual format in the formats field 330 to cause the processor to generate the visual representation 114a. As another example, the user may select the “Container” visual format in the formats field 330 to cause the processor to generate the visual representation 114b.

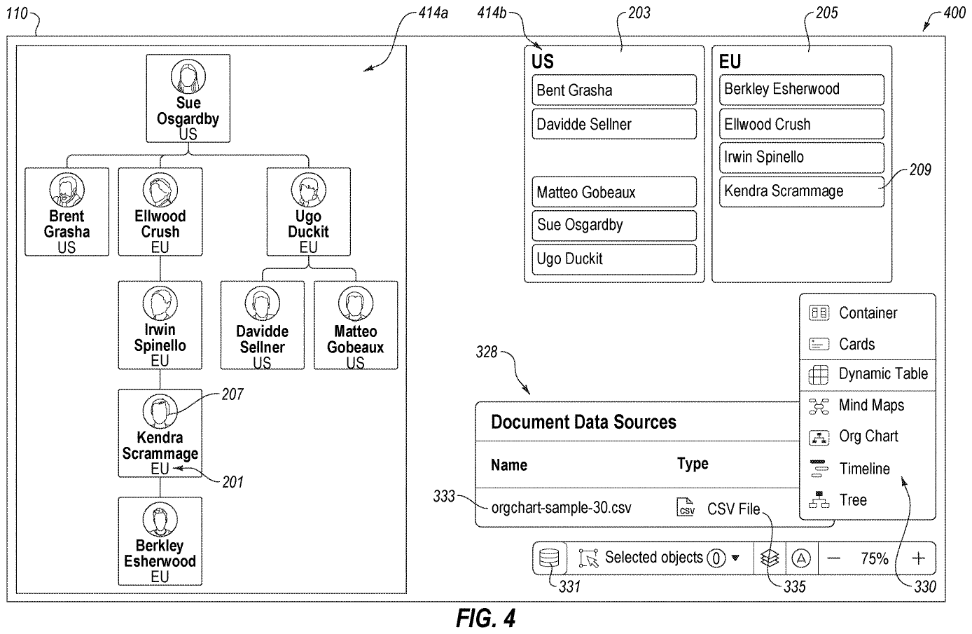

FIG. 4 illustrates a graphical representation of a UI 400 including the canvas 110 of FIG. 1 and two visual representations 414a-b that have been modified or updated, arranged in accordance with at least one embodiment described herein. The UI 400 may be provided by the browser 108 of FIG. 1. For instance, the browser 108 in cooperation with the processor 104 may present the UI 400 of FIG. 4 to a user through and/or on the display 118. The UI 400 may correspond to the UI 300 of FIG. 3.

With combined reference to FIGS. 1 and 4, in some embodiments, the user may modify or otherwise change the visual representations 114 via the canvas 110 to generate the visual representations 414a-b of FIG. 4. The user may provide input effective to modify information that is displayed in one or more of the visual representations 114 (e.g., user input effective to modify one or more of the visual representations 114). For example, as shown in FIG. 4, the user input modifies the location field 201 corresponding to Kendra Scrammage such that the visual representation 414a indicates that she works or resides in the EU instead of the US (as shown in FIGS. 2 and 3). As another example, the user may type new names, locations, or other appropriate information for one or more of the people displayed in the visual representations 114.

The processor 104 may update one or more of the visual representations 114 when a change is made to another visual representation 114 (e.g., based on modifications to other visual representations 114). For example, the processor 104 may update the visual representation 114b such that the visual representation 414b displays the name card 209 associated with Kendra Scrammage within the location container 205 corresponding to the EU based on the changes to the location field 201 associated with Kendra Scrammage in the visual representation 414a. Additionally or alternatively, the processor 104 may update the chart 112 when a change is made to one or more of the visual representations 114. For example, the processor 104 may cause the information stored in the corresponding pre-determined fields 219 to be changed to indicate that Kendra Scrammage either works or resides in the EU instead of the US. To determine a change is made to one or more of the visual representations 114, the processor 104 may compare the information in the visual representations 114 to the source data 116 or any other appropriate data. If the processor 104 identifies a difference, the processor 104 may determine a change was made. Further, the processor 104 may update the visual representations 114 when a change is made to the chart 112. The processor 104 may determine a change is made to the chart 112 in the same or similar manner as the visual representations 114 but with regard to the chart 112 instead.

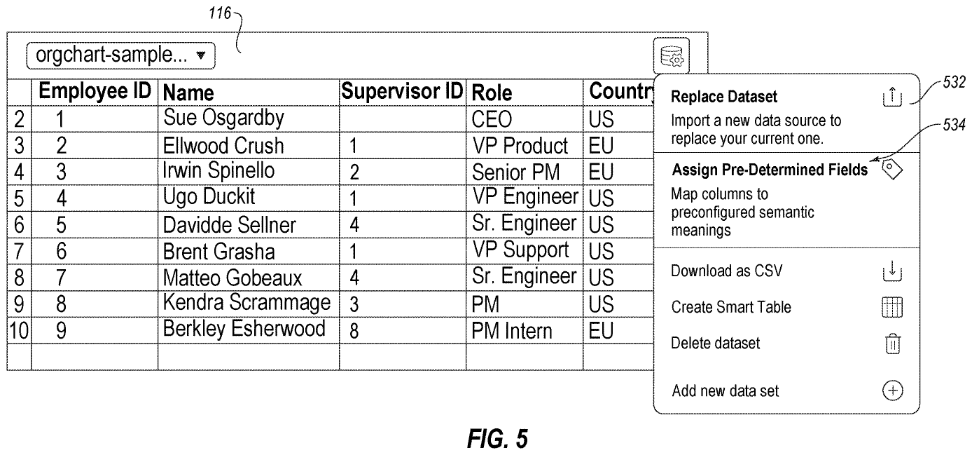

FIG. 5 illustrates an example of the source data 116 of FIG. 1 and a menu 532 including a selection field 534 to associate the fields 217 within the source data 116 with the pre-determined fields 219 of the chart 112, arranged in accordance with at least one embodiment described herein. The example of the source data 116 includes a known CSV schema similar to Table 1. With combined reference to FIGS. 1, 2, and 5, the processor 104 may cause the menu 532 including the selection field 534 to be displayed within the canvas 110.

The selection field 534 may be configured to receive user input effective to assign the fields 217 of the source data 116 to the pre-determined fields 219 of the chart 112. For example, the user may click, touch, or otherwise engage with the selection field 534 to cause the processor 104 to assign the fields 217 of the source data 116 to the pre-determined fields 219 of the chart 112.

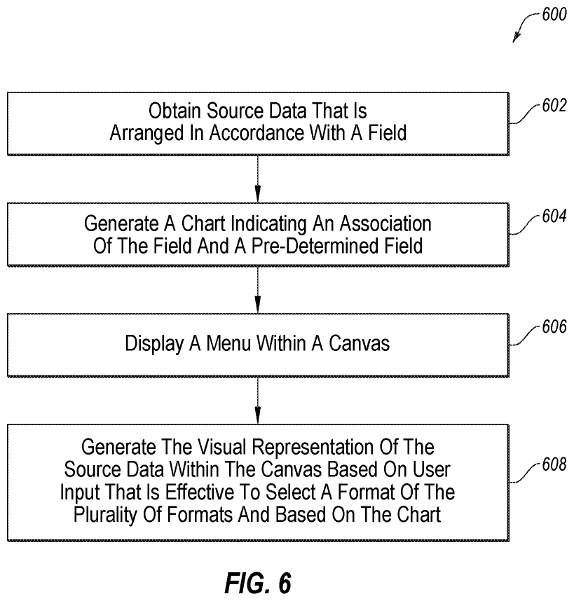

FIG. 6 illustrates a flowchart of an example method 600 to generate multiple visual representations based on source data, in accordance with at least one embodiment described in the present disclosure. The method 600 may be performed by any suitable system, apparatus, or device with respect to generating multiple visual representations based on source data. For example, the processors 103 and/or 104 of FIG. 1 may perform or direct performance of one or more of the operations associated with the method 600 with respect to generating multiple visual representations based on source data. The method 600 may include one or more blocks 602, 604, 606, or 608. Although illustrated with discrete blocks, the steps and operations associated with one or more of the blocks of the method 600 may be divided into additional blocks, combined into fewer blocks, or eliminated, depending on the particular implementation.

At block 602, source data that is arranged in accordance with a field may be obtained. For example, the processor 104 may obtain the source data 116 from the data storage 122, the canvas server 101, or the storage medium 106. At block 604, a chart indicating an association of the field and a pre-determined field may be generated. For example, the processor 104 may generate the chart 112 to indicate associations between fields 217 of the source data 116 and the pre-determined fields 219 of the chart 112.

At block 606, a menu may be displayed within a canvas. The menu may identify multiple formats for generating visual representations of the source data within the canvas. For example, the processor 104 may cause the menu 328 to be displayed within the canvas 110 via the display 118. At block 608, a plurality of visual representations of the source data may be generated within the canvas. The plurality of visual representations may be generated based on the chart or user input effective to select two or more formats of the plurality of formats. For example, the processor 104 may cause the visual representations 114 to be displayed within the canvas 110 via the display 118.

Modifications, additions, or omissions may be made to the method 600 without departing from the scope of the present disclosure. For example, the operations of method 600 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

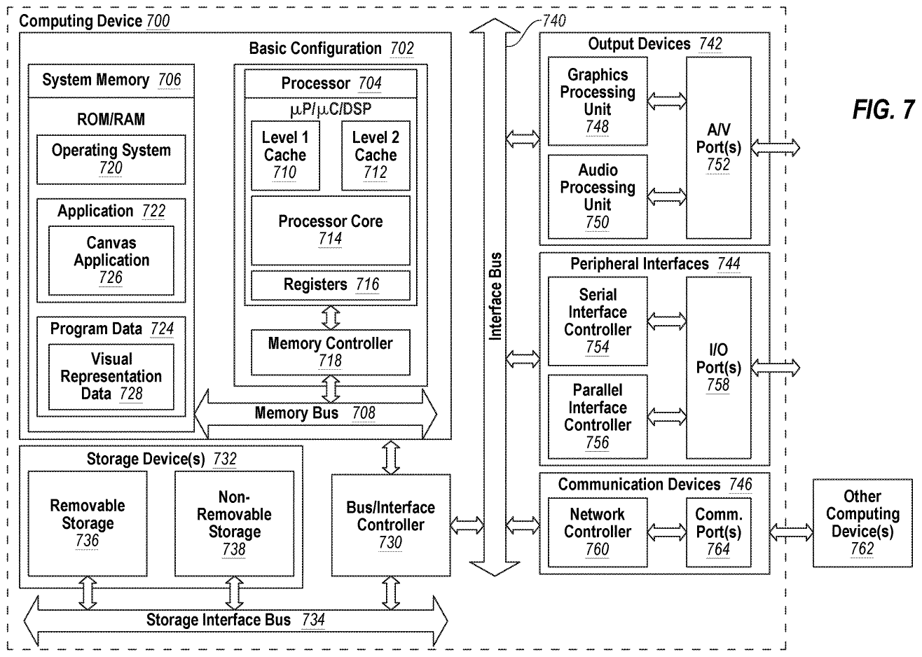

FIG. 7 is a block diagram illustrating an example computing device 700 that is arranged to facilitate generation of multiple visual representations based on source data, arranged in accordance with at least one embodiment described herein. The computing device 700 may include, be included in, or otherwise correspond to either or both of the computing device 102 or the canvas server 101 of FIG. 1. In a basic configuration 702, the computing device 700 typically includes one or more processors 704 and a system memory 706. A memory bus 708 may be used to communicate between the processor 704 and the system memory 706.

Depending on the desired configuration, the processor 704 may be of any type including, but not limited to, a microprocessor (μP), a microcontroller (μC), a digital signal processor (DSP), or any combination thereof. The processor 704 may include one or more levels of caching, such as a level one cache 710 and a level two cache 712, a processor core 714, and registers 716. The processor core 714 may include an arithmetic logic unit (ALU), a floating point unit (FPU), a digital signal processing core (DSP Core), or any combination thereof. An example memory controller 718 may also be used with the processor 704, or in some implementations the memory controller 718 may include an internal part of the processor 704.

Depending on the desired configuration, the system memory 706 may be of any type including volatile memory (such as RAM), nonvolatile memory (such as ROM, flash memory, etc.), or any combination thereof. The system memory 706 may include an operating system 720, one or more applications 722, and program data 724. The application 722 may include a canvas application 726 that is arranged to facilitate generation of multiple visual representations based on source data. The program data 724 may include visual representation data 728 (which may include, be included in, or otherwise correspond to the chart 112, the visual representations 114, or the source data 116 of FIG. 1) as is described herein. In some embodiments, the application 722 may be arranged to operate with the program data 724 on the operating system 720 such that one or more methods may be provided as described herein.

The computing device 700 may have additional features or functionality, and additional interfaces to facilitate communications between the basic configuration 702 and any involved devices and interfaces. For example, a bus/interface controller 730 may be used to facilitate communications between the basic configuration 702 and one or more data storage devices 732 via a storage interface bus 734. The data storage devices 732 may be removable storage devices 736, non-removable storage devices 738, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer-readable instructions, data structures, program modules, or other data.

The system memory 706, the removable storage devices 736, and the non-removable storage devices 738 (which may include, be included in, or otherwise correspond to one or more of the storage mediums 106 or 111 or the data storage 122) are examples of computer storage media or non-transitory computer-readable media. Computer storage media or non-transitory computer-readable media includes RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other non-transitory medium which may be used to store the desired information and which may be accessed by the computing device 700. Any such computer storage media or non-transitory computer-readable media may be part of the computing device 700.

The computing device 700 may also include an interface bus 740 to facilitate communication from various interface devices (e.g., output devices 742, peripheral interfaces 744, and communication devices 746) to the basic configuration 702 via the bus/interface controller 730. The output devices 742 include a graphics processing unit 748 and an audio processing unit 750, which may be configured to communicate to various external devices such as a display (e.g., display 118 of FIG. 1) or speakers via one or more A/V ports 752. Diagrams, flowcharts, visual representations, organizational charts, connectors, and/or other graphical objects generated by the canvas application 726 may be output through the graphics processing unit 748 to such a display. The peripheral interfaces 744 include a serial interface controller 754 or a parallel interface controller 756, which may be configured to communicate with external devices such as input devices (e.g., keyboard, mouse, pen, voice input device, touch input device, etc.), sensors, or other peripheral devices (e.g., printer, scanner, etc.) via one or more I/O ports 758. Such input devices may be operated by a user to provide input to the canvas application 726, which may be effective to generate, modify, or otherwise interact with visual representations and/or charts within the canvas application 726. The communication devices 746 include a network controller 760, which may be arranged to facilitate communications with one or more other computing devices 762 over a network communication link via one or more communication ports 764.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term “computer-readable media” as used herein may include both storage media and communication media.

The computing device 700 may be implemented as a portion of a small-form factor portable (or mobile) electronic device such as a smartphone, a personal data assistant (PDA) or an application-specific device. The computing device 700 may also be implemented as a personal computer including tablet computer, laptop computer, and/or non-laptop computer configurations, or a server computer including both rack-mounted server computer and blade server computer configurations.

Embodiments described herein may be implemented using computer-readable media for carrying or having computer-executable instructions or data structures stored thereon. Such computer-readable media may be any available media that may be accessed by a general-purpose or special-purpose computer. By way of example, such computer-readable media may include non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions may include, for example, instructions and data which cause a general-purpose computer, special-purpose computer, or special-purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
obtaining source data that is arranged in accordance with a field;
generating a chart indicating an association of the field and a pre-determined field;
displaying a menu within a canvas, the menu identifying a plurality of formats for generating visual representations to be representative of the source data within the canvas; and
generating a plurality of visual representations of the source data within the canvas based on the chart and user input that is effective to select two or more formats of the plurality of formats.

2. The method of claim 1, wherein:
the plurality of visual representations of the source data comprise a first visual representation and a second visual representation; and
the first visual representation and the second visual representation represent information within the source data in different formats.

3. The method of claim 2 further comprising:
receiving user input effective to modify the first visual representation;
updating the second visual representation based on modifications to the first visual representation; and
updating the chart based on modifications to the first visual representation.

4. The method of claim 1, wherein:
the source data comprises a known schema; and
the method further comprises associating the pre-determined field with the field based on the known schema.

5. The method of claim 1, wherein:
the source data comprises an unknown schema; and
the method further comprises associating the pre-determined field with the field based on additional user input effective to indicate the association of the pre-determined field and the field.

6. The method of claim 1, wherein:
the source data comprises a known schema; and
the method further comprises receiving additional user input effective to assign the field to the pre-determined field.

7. The method of claim 1, wherein:
the source data is arranged in accordance with a first format comprising the field;
the chart is arranged in accordance with a second format comprising the pre-determined field; and
the association of the field and the pre-determined field in the chart indicates a relationship between the second format and the first format.

8. The method of claim 1, wherein the plurality of formats for generating the visual representations comprises at least two of:
a container visual representation;
a card visual representation;
a dynamic table visual representation;
a mind map visual representation;
an organizational chart visual representation;
a timeline visual representation; or
a tree visual representation.

9. A non-transitory computer-readable medium having computer-readable instructions stored thereon that are executable by a processor to perform or control performance of operations comprising:
obtaining source data that is arranged in accordance with a field;
generating a chart indicating an association of the field and a pre-determined field;
displaying a menu within a canvas, the menu identifying a plurality of formats for generating visual representations to be representative of the source data within the canvas; and
generating a plurality of visual representations of the source data within the canvas based on the chart and user input that is effective to select two or more formats of the plurality of formats.

10. The non-transitory computer-readable medium of claim 9, wherein:
the plurality of visual representations of the source data comprise a first visual representation and a second visual representation; and
the first visual representation and the second visual representation represent information within the source data in different formats.

11. The non-transitory computer-readable medium of claim 10, wherein the operations further comprise:
receiving user input effective to modify the chart;
updating the first visual representation based on modifications to the chart; and
updating the second visual representation based on modifications to the chart.

12. The non-transitory computer-readable medium of claim 10, wherein the operations further comprise:
receiving user input effective to modify the first visual representation;
updating the second visual representation based on modifications to the first visual representation; and
updating the chart based on modifications to the first visual representation.

13. The non-transitory computer-readable medium of claim 9, wherein:
the source data comprises a known schema; and
the operations further comprise associating the pre-determined field with the field based on the known schema.

14. The non-transitory computer-readable medium of claim 9, wherein:
the source data comprises an unknown schema; and
the operations further comprise associating the pre-determined field with the field based on additional user input effective to indicate the association of the pre-determined field and the field.

15. A system comprising:
one or more computer-readable storage media configured to store instructions; and
one or more processors communicatively coupled to the one or more computer-readable storage media and configured to, in response to execution of the instructions, cause the system to perform operations, the operations comprising:
obtaining source data that is arranged in accordance with a field;
generating a chart indicating an association of the field and a pre-determined field;
displaying a menu within a canvas, the menu identifying a plurality of formats for generating visual representations to be representative of the source data within the canvas; and
generating a plurality of visual representations of the source data within the canvas based on the chart and user input that is effective to select two or more formats of the plurality of formats.

16. The system of claim 15, wherein:
the plurality of visual representations of the source data comprise a first visual representation and a second visual representation; and
the first visual representation and the second visual representation represent information within the source data in different formats.

17. The system of claim 16, wherein the operations further comprise:
receiving user input effective to modify the first visual representation;
updating the second visual representation based on modifications to the first visual representation; and
updating the chart based on modifications to the first visual representation.

18. The system of claim 16, wherein the operations further comprise:
receiving user input effective to modify the chart;
updating the first visual representation based on modifications to the chart; and
updating the second visual representation based on modifications to the chart.

19. The system of claim 15, wherein:
the source data comprises a known schema; and
the operations further comprise associating the pre-determined field with the field based on the known schema.

20. The system of claim 15, wherein:
the source data comprises a known schema; and
the operations further comprises receiving additional user input effective to assign the field to the pre-determined field.
